(19) United States
(12) Patent Application Publication
(10) Pub. No.: US 2024/0424418 A1
(43) Pub. Date: Dec. 26, 2024

(54) WEARABLE NON-SLIP GRIPS FOR USE WITH PERIPHERAL GAMING DEVICE

(71) Applicant: GGz Inc., Collingwood (CA)

(72) Inventor: Kale SWINWOOD-SKY, Collingwood (CA)

(73) Assignee: GGz Inc., Collingwood (CA)

(21) Appl. No.: 18/748,452

(22) Filed: Jun. 20, 2024

Related U.S. Application Data
(60) Provisional application No. 63/510,218, filed on Jun. 26, 2023.

(51) Int. Cl. A63F 13/98

(52) U.S. Cl. CPC A63F 13/98

(57) ABSTRACT

A wearable gaming grip having a base layer, an adhesive layer, and a gripping member. The base layer includes a first engagement surface and a second engagement surface opposite to the first engagement surface. The adhesive layer operably engages with the first engagement surface and is adapted to adhere to a user's digit. The gripping member operably engages with the second engagement surface and adapted to engage with one or more input components of a peripheral gaming device. A plurality of voids is also defined between the first engagement surface and the second engagement surface for allowing air to pass through the base layer. A protective sheet also operably engages with the adhesive layer to prevent adhesion with the adhesive layer.

### REFERENCE TO RELATED APPLICATIONS

This application claims the benefit of U.S. Provisional Application Ser. No. 63/510,218, filed on Jun. 26, 2023; the disclosure of which is incorporated herein by reference.

### TECHNICAL FIELD

This disclosure is directed to a wearable member for use with a peripheral gaming device.

### BACKGROUND ART

In the gaming arena, usage of peripheral gaming devices or computing tools, such as gaming controllers, keyboards, or mice, are generally required when playing virtual video games. When using such peripheral gaming devices, these peripheral gaming devices may lead to unwanted perspiration thus compromising the integrity of a user's grip. Such lack of grip when handling peripheral gaming devices may lead to lack of accuracy, movement, and coordination due to the user's fingers or digits sliding and/or slipping off input components of these peripheral gaming devices (e.g., button, joysticks, triggers, keys, etc.). Even though perspiration is an issue, prolonged use of these peripheral gaming devices may also create skin irritation along surfaces of the user's fingers and hands due to constant rubbing and friction between the user's skin and these peripheral gaming devices.

To combat against these issues of irritation, perspiration, and lack of grip, gaming accessories have been introduced into the gaming space to relieve these issues. In one instance, covers made of silicon and other similar materials may be provided on these peripheral gaming devices to provide a barrier between the user's skin and the peripheral gaming devices. While such material may provide a cushion between the user's skin and the peripheral gaming device to eliminate skin irritation, such covers fail to combat against perspiration when the user is handling these peripheral gaming devices. With perspiration being an issue, users of these covers also lose grip when holding these covers thus leading to lack of accuracy, movement, and coordination during a virtual video game. In yet another instance, grip paste or compounds are also used in the gaming space to enhance grip along users' hands and digits. While grip may be combatted with these pastes, these grip pastes fail to provide a suitable barrier between the user's skin and the peripheral gaming device to eliminate skin irritation that result in blisters or sores.

### SUMMARY OF THE INVENTION

As such, a need for a device or a product is desired that provides gamers and users of peripheral gaming devices with an enhanced grip and protection against skin irritation. The presently disclosed wearable gaming grip provides gamers and users of peripheral gaming devices with the ability of having a barrier between the user's skin and the peripheral gaming device to eliminate skin irritation. The presently disclosed wearable gaming grip is also configured to be breathable and/or allow air to pass through the wearable gaming grip to prevent excessive perspiration when gaming for extensive periods of time. The presently disclosed wearable gaming grip also includes integrated gripping members that interact with input components of peripheral gaming devices to improve grip and prevent incidental sliding or slippage.

In one aspect, an exemplary embodiment of the present disclosure may provide a wearable gaming grip. The wearable gaming grip includes a base layer that has a first engagement surface and a second engagement surface opposite to the first engagement surface. The wearable gaming grip also includes an adhesive layer that operably engages with the first engagement surface and adapted to adhere to a user's digit. The wearable gaming grip includes a gripping member that operably engages with the second engagement surface and adapted to engage with one or more input components of a peripheral gaming device.

In another aspect, an exemplary embodiment of the present disclosure may provide a wearable gaming grip. The wearable gaming grip includes a base layer that has a first engagement surface and a second engagement surface opposite to the first engagement surface. The wearable gaming grip also includes a plurality of voids defined between the first engagement surface and the second engagement surface for allowing air to pass through the base layer. The wearable gaming grip also includes an adhesive layer that operably engages with the first engagement surface and adapted to adhere to a user's digit. The wearable gaming grip also includes a protective sheet that operably engages with the adhesive layer to prevent adhesion with the adhesive layer. The wearable gaming grip also includes a gripping member that operably engages with the second engagement surface and adapted to engage with one or more input components of a peripheral gaming device.

In another aspect, an exemplary embodiment of the present disclosure may provide a method of gripping a joystick of a peripheral gaming device. The method comprising steps of: removing a protective sheet of a wearable gaming grip from an adhesive layer of the wearable gaming grip; resting a gripping member and a base layer of the wearable gaming grip on the joystick of the peripheral gaming device; adhering a user's digit on an adhesive layer of the wearable gaming grip; wrapping at least one portion of the adhesive layer of the wearable gaming grip about the user's digit; and gripping one or more input components of the peripheral gaming device with a gripping member of the wearable gaming grip.

In yet another aspect, an exemplary embodiment of the present disclosure may provide a wearable gaming grip. The wearable gaming grip includes a base layer having a first engagement surface and a second engagement surface opposite to the first engagement surface; an adhesive layer operably engaged with the first engagement surface and adapted to adhere to a user's digit; and a plurality of gripping members operably engaged with the second engagement surface and adapted to engage with one or more input components of a peripheral gaming device.

This exemplary embodiment or another exemplary embodiment may further include a plurality of voids defined between the first engagement surface and the second engagement surface of the base layer; wherein a flow of air passes through the base layer at one or more voids of the plurality of voids. This exemplary embodiment or another exemplary embodiment may further include that each void of the plurality of voids is defined between two adjacent gripping members of the plurality of gripping members. This exemplary embodiment or another exemplary embodiment may further include that the plurality of voids are further defined between the first engagement surface and the second engagement surface of the adhesive layer. This exemplary embodiment or another exemplary embodiment may further include a first diameter defining each void of the plurality of voids; and a second diameter defining each gripping member of the plurality of gripping members; wherein the second diameter is greater than the first diameter. This exemplary embodiment or another exemplary embodiment may further include a first side; a second side transversely opposite to the first side; a first extension extending outwardly from the first side; and a second extension extending outwardly from second side opposite to the first extension; wherein the first extension covers a first portion of the user's digit; and wherein the second extension covers a second portion of the user's digit. This exemplary embodiment or another exemplary embodiment may further include a first width defined by the first extension; and a second width defined by the second extension that is less than the second width. This exemplary embodiment or another exemplary embodiment may further include a first length defined by the first extension; and a second length defined by the second extension that is equal to the first length. This exemplary embodiment or another exemplary embodiment may further include that the first extension defines a curvilinear two-dimensional shape. This exemplary embodiment or another exemplary embodiment may further include a first end; a second end longitudinally opposite to the second end; a first portion defining the first extension and the second extension; a second portion defined between the first end and the first portion; and a third portion defined between the second end and the first portion and is longitudinally opposite to the first portion. This exemplary embodiment or another exemplary embodiment may further include that the first portion is configured to engage with a first surface of the user's digit; and wherein the second portion and the third portion are each configured to operably engage with a second surface of the user's digit that is behind the first surface. This exemplary embodiment or another exemplary embodiment may further include that the plurality of gripping members is engaged with the first portion and free from engaging with the second portion and the third portion. This exemplary embodiment or another exemplary embodiment may further include that each gripping member of the plurality of gripping members defines a circular two-dimensional shape. This exemplary embodiment or another exemplary embodiment may further include that each gripping member of the plurality of gripping members defines an ovoidal two-dimensional shape. This exemplary embodiment or another exemplary embodiment may further include a protective sheet operably engaged with the adhesive layer to prevent adhesion with the adhesive layer.

In yet another aspect, an exemplary embodiment of the present disclosure may provide a method of gripping a joystick of a peripheral gaming device. The method comprising steps of: removing a protective sheet of a wearable gaming grip from an adhesive layer of the wearable gaming grip; resting a plurality of gripping members and a base layer of the wearable gaming grip on the joystick of the peripheral gaming device; adhering a user's digit on the adhesive layer of the wearable gaming grip; wrapping at least one portion of the adhesive layer of the wearable gaming grip about the user's digit; and gripping one or more input components of the peripheral gaming device with the one or more gripping members of the plurality of gripping members.

This exemplary embodiment or another exemplary embodiment may further include a step of aligning a first portion of the base layer with the joystick of the peripheral gaming device and a first surface of the user's digit; wherein the plurality of gripping members is disposed on the first portion of the base layer. This exemplary embodiment or another exemplary embodiment may further include that the step of aligning the first portion of the base layer with the joystick further comprises: aligning a first extension of the base layer with a base of the user's digit; and aligning a second extension of the base layer with a tip of the user's digit. This exemplary embodiment or another exemplary embodiment may further include that the step of wrapping at least one portion of the adhesive layer of the wearable gaming grip about the user's digit further comprising: wrapping a second portion of the adhesive layer about the user's digit; wrapping a third portion of the adhesive layer about the user's digit and the second portion; adhering the second portion of the adhesive layer to the user's digit; and adhering the third portion of the adhesive layer to the user's digit and the third portion. This exemplary embodiment or another exemplary embodiment may further include steps of defining a plurality of voids inside of the base layer and the adhesive layer; and passing air through the base layer and the adhesive layer via the plurality of voids.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a rear, top, second side isometric perspective view of a wearable gaming grip in accordance with one aspect of the present disclosure.

FIG. 2 is a rear, bottom, second side isometric perspective view of the wearable gaming grip.

FIG. 3 is an exploded view of the wearable gaming grip.

FIG. 4 is a top plan view of the wearable gaming grip.

FIG. 5 is a bottom plan view of the wearable gaming grip.

FIG. 6 is a longitudinal sectional view taken in the direction of line 6-6 shown in FIG. 5.

FIG. 7 is an operational view of removing a protective sheet of the wearable gaming grip from an adhesive layer of the wearable gaming grip.

FIG. 8A is another operational view similar to FIG. 7, but the wearable gaming grip is introduced to a peripheral gaming device and a user's digit.

FIG. 8B is another operational view similar to FIG. 8A, but a gripping member of the wearable gaming grip rests on a joystick of the peripheral gaming device and the user's digit rests on the adhesive layer provided on the base layer.

FIG. 8C is another operational view similar to FIG. 8B, but the wearable gaming grip is wrapped around and attached to the user's digit by the adhesive layer.

FIG. 9 is a bottom plan view of a wearable gaming grip in accordance with another aspect of the present disclosure.

Similar numbers refer to similar parts throughout the drawings.

### DETAILED DESCRIPTION

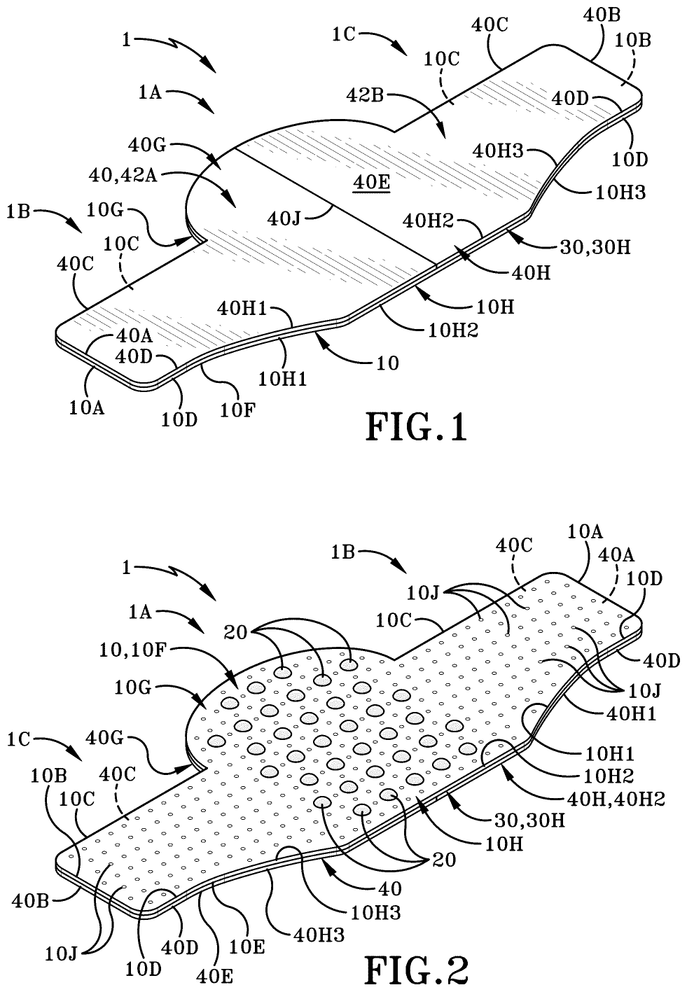

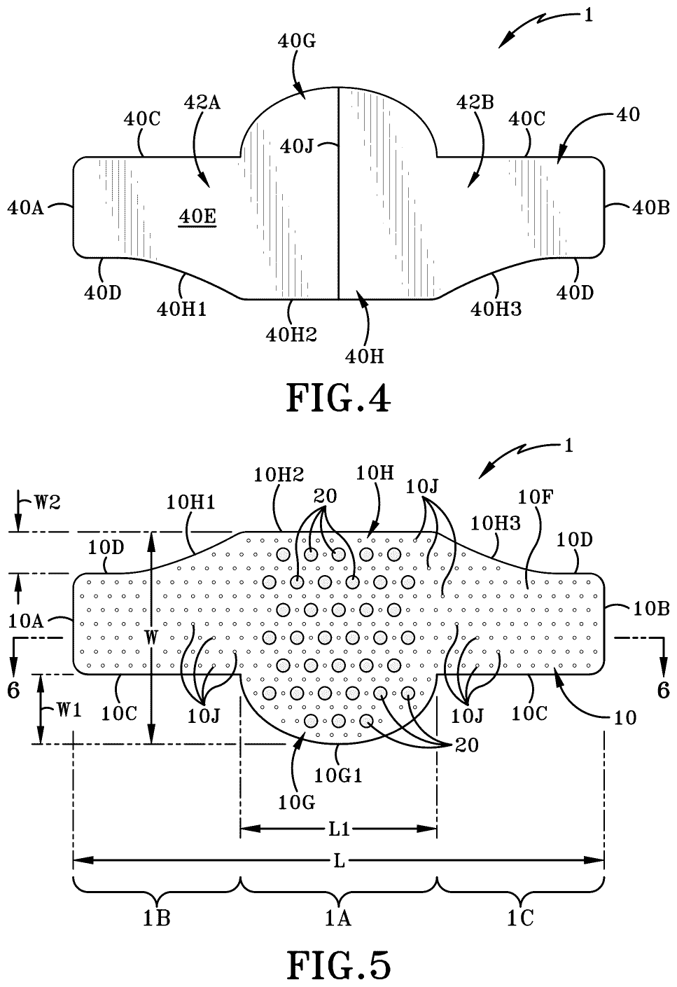

FIGS. 1-8C illustrates a wearable gaming grip generally referred to as reference numeral 1. Wearable gaming grip 1 is configured to temporarily operably engage with a user's digit to aid and improve gaming performance when operating or interacting with a peripheral gaming device. More particularly, wearable gaming grip 1 is configured to aid and improve gaming performance for a user when operating or interacting with one or more input components of a peripheral gaming device (such as joysticks, buttons, triggers, keys and other input components provided on peripheral gaming devices) to protect sensitivity, enhance and improve grip with one or more input components, and prevent sliding or slippage along an input component of the peripheral gaming device that may be caused by perspiration. Such components and features of the wearable gaming grip 1 are now discussed in greater detail below.

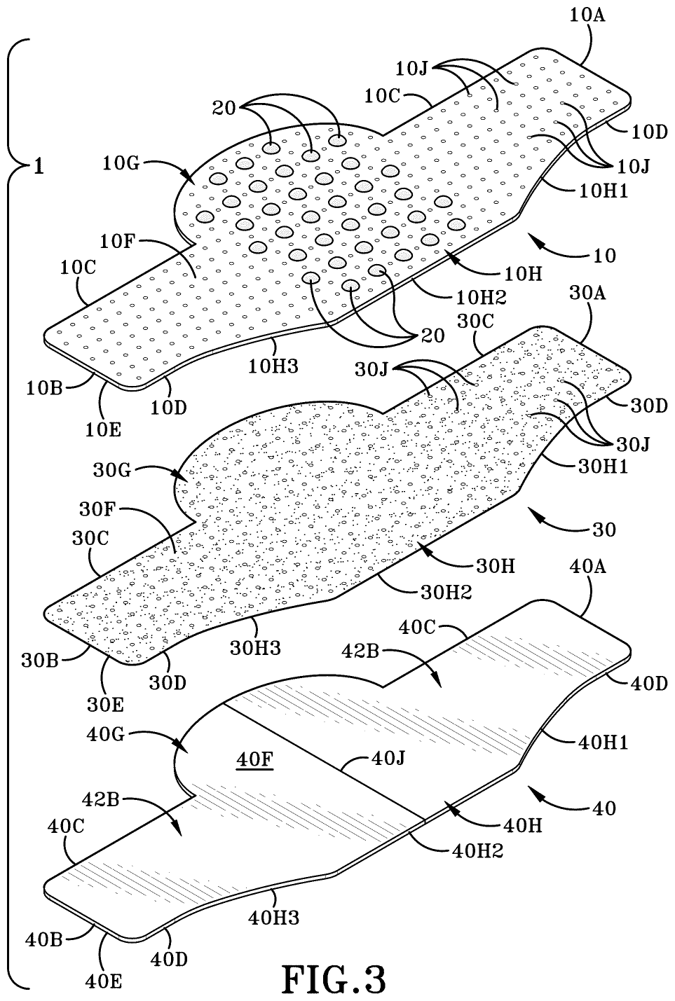

Wearable gaming grip 1 includes a base layer 10. As best seen in FIG. 3, base layer 10 includes a first end 10A, a second end 10B longitudinally opposite to the first end 10A, and a longitudinal axis defined therebetween. Base layer 10 also defines an overall or primary length (denoted by double arrows labeled “L” in FIG. 5) that is measured between the first end 10A and the second end 10B. Base layer 10 also includes a first side 10C extending between the first end 10A and the second end 10B, a second side 10D extending between the first end 10A and the second end 10B and is transversely opposite to the first side 10C, and a transverse axis defined therebetween. Base layer 10 also includes a top or first engagement surface 10E that is positioned vertically above the first end 10A, the second end 10B, the first side 10C, and the second side 10D, a bottom or second engagement surface 10F that is positioned vertically below the first end 10A, the second end 10B, the first side 10C, and the second side 10D, and a vertical axis defined between the first engagement surface 10E and the bottom engagement surface 10F.

Still referring to base layer 10, base layer 10 also includes a first extension 10G. As best seen in FIG. 3, first extension 10G protrudes outwardly from the first side 10C along the transverse axis of the base layer 10. In use, first extension 10G enables a portion of a user's digit to rest and be protected by the first extension 10G. First extension 10G also defines a first width (denoted by double arrows labeled “W1” in FIG. 5) that is measured between the first side 10C to an apex point 10G1 of the first extension 10G. First extension 10G also defines a first length (denoted by double arrows labeled “L1” in FIG. 5) that is less than the overall length “L” of the base layer 10.

In the present disclosure, first extension 10G defines a curvilinear and/or arcuate shape when viewed from a bottom plan view (see FIG. 5) to enable a portion of a user's digit (particularly a base portion of the user's digit) to rest and be protected by the first extension 10G. It is to be understood that any other geometric configuration of first extension 10G is entirely possible that enables a portion of a user's digit to rest and be protected by the first extension 10G. For example, instead of first extension 10G being curvilinear, first extension 10G may be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, or any other type of regular or irregular, symmetrical or asymmetrical configuration.

Still referring to base layer 10, base layer 10 also includes a second extension 10H. As best seen in FIG. 3, second extension 10H protrudes outwardly from the second side 10D along the transverse axis of the base layer 10. In the present disclosure, the second extension 10H is defined transversely opposite to the first extension 10G. Second extension 10H includes a first curvilinear edge 10H1 that extends outwardly from second side 10D to a planar edge 10H2 of the second extension 10H. Second extension 10H also includes a second curvilinear edge 10H3 that extends outwardly from second side 10D to the planar edge 10H2 and is longitudinally opposite to the first curvilinear edge 10H1. In use, second extension 10H enables a portion of a user's digit to rest and be protected by the second extension 10H. In the present disclosure, second extension 10H enables a portion of a user's digit (particularly a tip of the user's digit) to rest and be protected by the second extension 10H. Second extension 10H also defines a second width (denoted by double arrows labeled “W2” in FIG. 5) that is measured between the second side 10D to the planar edge 10H2. In the present disclosure, the second width W2 is less than the first width W1. In the present disclosure, base layer 10 also defines an overall or primary width (denoted by double arrows labeled “W” in FIG. 5) that is measured between the apex point 10G1 of first extension 10G to the planar edge 10H2 of the second extension 10H. In the present disclosure, second extension 10G also defines a second length that is found by subtracting the overall length “L” from the first length “L1” of the first extension 10G; the second length of the second extension 10H is greater than the first length “L1” of the first extension 10G.

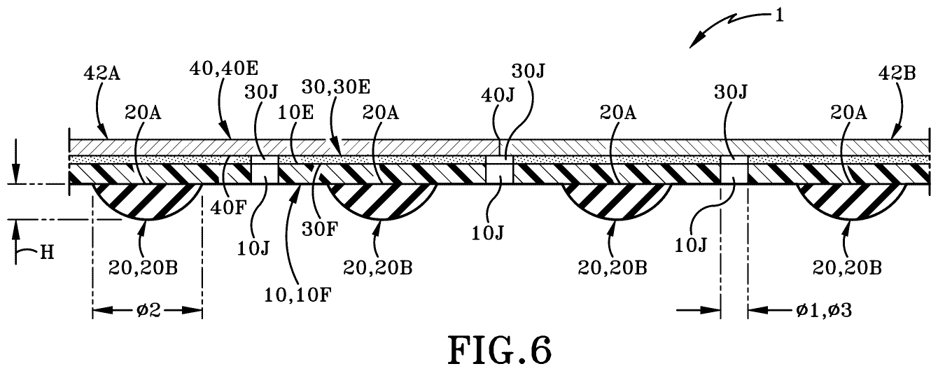

Still referring to base layer 10, base layer 10 also includes a plurality of voids or passageways 10J. As best seen in FIG. 6, each void of the plurality of voids 10J extends entirely through the base layer 10 between the first engagement surface 10E and the second engagement surface 10F; as such, the first engagement surface 10E and the second engagement surface 10F are in fluid communication with one another at each void of the plurality of voids 10J. Base layer 10 also defines a first diameter (denoted by double arrows labeled Ø1 in FIG. 6) for each void of the plurality of voids 10J. In use, the plurality of voids 10J allows for air to pass through the base layer 10 in order for the base layer 10 to be breathable. Such breathability of the base layer 10 may prevent against unwanted and/or excessive perspiration secreted from the user's hand or digit when wearable gaming grip 1 is operably engaged with the user's hand or digit.

Wearable gaming grip 1 also includes at least one gripping member 20 that operably engages with the base layer 10. In the present disclosure, wearing gaming grip 1 includes a plurality of gripping members 20 that operably engages with the base layer 10 (see FIGS. 2-3 and 5-6). As best seen in FIG. 6, each gripping member of the plurality of gripping members 20 includes an securement surface 20A that is permanently engaged with the second engagement surface 10F of the base layer 10. Still referring FIG. 6, each gripping member of the plurality of gripping members 20 also includes a gripping surface 20B that faces outwardly from the second engagement surface 10F and is opposite to a respective securement surface 20A of each gripping member of the plurality of gripping members 20. In use, one or more gripping surfaces 20B of the plurality of gripping members 20 are configured to contact and grip with at least one input components of a peripheral gaming device to prevent sliding or slippage of the user's digit.

Still referring to the plurality of gripping members 20, each gripping member of the plurality of gripping members 20 defines a second diameter (denoted by double arrows labeled Ø2 in FIG. 6). In the present disclosure, the second diameter Ø2 of each gripping member of the plurality of gripping members 20 is greater than the first diameter Ø1 of each void of the plurality of voids 10J defined by base layer 10. Each gripping member of the plurality of gripping members 20 also defines a height (denoted by double arrows labeled H in FIG. 6). In the present disclosure, the second diameter Ø2 of each gripping member of the plurality of gripping members 20 is greater than the height H of each gripping member of the plurality of gripping members 20. In other exemplary embodiments, a wearable gaming grip discussed herein may have any suitable diameters for each void of a plurality of voids, diameters for each gripping member of a plurality of gripping members, and heights for each gripping member of a plurality of gripping members dictated by the implementation of wearable gaming device, including the size, shape, and configuration of the wearable gaming device, the types of input components of a peripheral gaming device, and the intended digit or area at which the wearable gaming device will be worn.

In the present disclosure, each gripping member of the plurality of gripping members 20 also defines a parabolic-shaped or dome-shaped configuration for enabling a user's digit to contact and grip at least one input components of a peripheral gaming device to prevent sliding or slippage (see FIGS. 1-6). In an alternative embodiment, an alternative wearable gaming grip 100 may include rounded and/or ovoidal-shaped gripping members 120 that are nested inside one another to mimic an outline of a user's fingerprints or a user's digit.

It is to be understood that any other geometric configuration for gripping members 20, 20′ discussed herein is entirely possible to enhance and improve a user's grip when interacting with at least one input components of a peripheral gaming device. For example, instead of gripping members 20, 20′ defining a parabolic shape, dome shape, or a nesting configuration, gripping members 20, 20′ may be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, or any other type of regular or irregular, symmetrical or asymmetrical configuration.

Wearable gaming grip 1 also includes an adhesive layer 30 that operably engages with the base layer 10. In the present disclosure, the size, shape, and configuration of the adhesive layer 30 substantially matches with the size, shape, and configuration of the base layer 10, which are discussed in greater detail below. In use, adhesive layer 30 is configured as a temporary adhesive member that enables the wearable gaming grip 1 to be maintained on a user's digit or hand for a temporary amount of time when using a peripheral gaming device. Such features and components of adhesive layer 30 are discussed in greater detail below.

As best seen in FIG. 3, adhesive layer 30 includes a first end 30A, a second end 30B longitudinally opposite to the first end 30A, and a longitudinal axis defined therebetween. Upon assembly, the first end 30A aligns with the first end 10A of the base layer 10, and the second end 30B aligns with the second end 10B of the base layer 10. Adhesive layer 30 also includes a first side 30C extending between the first end 30A and the second end 30B, a second side 30D extending between the first end 30A and the second end 30B and is transversely opposite to the first side 300, and a transverse axis defined therebetween. Upon assembly, the first side 30C aligns with the first side 10C of the base layer 10, and the second side 30D aligns with the second side 10D of the base layer 10.

Adhesive layer 30 also includes a top or first engagement surface 30E that is positioned vertically above the first end 30A, the second end 30B, the first side 30C, and the second side 30D, a bottom or second engagement surface 30F that is positioned vertically below the first end 30A, the second end 30B, the first side 300, and the second side 30D, and a vertical axis defined between the first engagement surface 30E and the bottom engagement surface 30F. Upon assembly, the first engagement surface 30E is spaced apart from the base layer 10 and includes a temporary adhesive material to enable the adhesive layer 30 to temporary adhere to a user's digit or hand. Upon assembly, the second engagement surface 30F permanently engages with the first engagement surface 10E of the base layer 10 such that the adhesive layer 30 remains with the base layer 10.

Adhesive layer 30 also includes a first extension 30G. As best seen in FIG. 3, first extension 30G protrudes outwardly from the first side 30C along the transverse axis of the adhesive layer 30. Upon assembly, first extension 30G aligns with the first extension 10G of base layer 10 (see FIG. 2). In use, first extension 30G enables a portion of a user's digit to adhere to the wearable gaming grip 1 while also being protected by the first extension 30G. In the present disclosure, the first extension 30G also defines the first width “W1” and the first length “L1” similar to the first extension 10G of the base layer 10.

In the present disclosure, first extension 30G defines a curvilinear and/or arcuate shape when viewed from a bottom plan view (see FIG. 5) to enable a portion of a user's digit (particularly a base portion of the user's digit) to rest and be protected by the first extension 30G. It is to be understood that any other geometric configuration of first extension 30G is entirely possible that enables a portion of a user's digit to rest and be protected by the first extension 30G. For example, instead of first extension 30G being curvilinear, first extension 30G may be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, or any other type of regular or irregular, symmetrical or asymmetrical configuration.

Still referring to adhesive layer 30, adhesive layer 30 also includes a second extension 30H. As best seen in FIG. 3, second extension 30H protrudes outwardly from the second side 30D along the transverse axis of the adhesive layer 30. In the present disclosure, the second extension 30H is defined transversely opposite to the first extension 30G. Second extension 30H includes a first curvilinear edge 30H1 that extends outwardly from second side 30D to a planar edge 30H2. Second extension 30H also includes a second curvilinear edge 30H3 that extends outwardly from second side 30D to the planar edge 30H2 and is longitudinally opposite to the first curvilinear edge 30H1. Upon assembly, second extension 30H aligns with the second extension 10H of base layer 10 such that the first curvilinear edge 30H1 aligns with the first curvilinear edge 10H1 of base layer 10, the planar edge 30H2 aligns with the planar edge 10H2 of base layer 10, and the second curvilinear edge 30H3 aligns with the second curvilinear edge 10H3 of base layer 10. In the present disclosure, the second extension 30H also defines the second width “W2” and the second length (not illustrated) similar to the second extension 10H of the base layer 10.

In use, second extension 30H enables a portion of a user's digit to rest and be protected by the second extension 30H. In the present disclosure, second extension 30H enables a portion of a user's digit (particularly a tip of the user's digit) to adhere with the wearable gaming grip 1 while being protected by the second extension 30H.

Still referring to adhesive layer 30, adhesive layer 30 also includes a plurality of voids or passageways 30J. As best seen in FIG. 6, each void of the plurality of voids 30J extends entirely through the adhesive layer 30 between the first engagement surface 30E and the second engagement surface 30F. As such, the first engagement surface 30E and the second engagement surface 30F are in fluid communication with one another at each void of the plurality of voids 30J. Adhesive layer 30 also defines a third diameter (denoted by double arrows labeled Ø3 in FIG. 6) for each void of the plurality of voids 30J; the third diameter Ø3 of each void of the plurality of voids 30J is equal with the first diameter Ø1 of each void of the plurality of voids 10J.

Upon assembly of wearable gaming grip 1, the plurality of voids 30J is coaxial with the plurality of voids 10J of the base layer 10. As such, each void of the plurality of voids 30J of adhesive layer 30 is aligned with a respective void of the plurality of voids 10J of base layer 10. In use, the plurality of voids 10J of base layer 10 and the plurality of voids 30J of adhesive layer 30 allow for air to pass through the base layer 10 and the adhesive layer 30 in order for the wearable gaming grip 1 to be breathable. Such breathability of the base layer 10 and the adhesive layer 30 may prevent against unwanted and/or excessive perspiration secreted from the user's hand or digit when the adhesive layer 30 is operably engaged with the user's hand or digit.

Wearable gaming grip 1 also includes a temporary or protective sheet 40 that removably engages with the adhesive layer 30. In the present disclosure, the size, shape, and configuration of the protective sheet 40 substantially matches with the size, shape, and configuration of each of the base layer 10 and the adhesive layer 30, which are discussed in greater detail below. In use, protective sheet 40 acts a temporary layer or material that shields the first engagement surface 30E from being used and adhering to undesired surfaces. Such features and components of protective sheet 40 are discussed in greater detail below.

As best seen in FIG. 3, protective sheet 40 includes a first end 40A, a second end 40B longitudinally opposite to the first end 40A, and a longitudinal axis defined therebetween. Upon assembly, the first end 40A aligns with the first end 30A of the adhesive layer 30, and the second end 40B aligns with the second end 30B of the adhesive layer 30. Protective sheet 40 also includes a first side 40C extending between the first end 40A and the second end 40B, a second side 40D extending between the first end 40A and the second end 40B and is transversely opposite to the first side 40C, and a transverse axis defined therebetween. Upon assembly, the first side 40C aligns with the first side 30C of the adhesive layer 30, and the second side 40D aligns with the second side 30D of the adhesive layer 30.

Protective sheet 40 also includes a top or first engagement surface 40E that is positioned vertically above the first end 40A, the second end 40B, the first side 40C, and the second side 40D, a bottom or second engagement surface 40F that is positioned vertically below the first end 40A, the second end 40B, the first side 40C, and the second side 40D, and a vertical axis defined between the first engagement surface 40E and the bottom engagement surface 40F. Upon assembly, the first engagement surface 40E is spaced apart from the base layer 10 and the adhesive layer 30. Upon assembly, the second engagement surface 40F temporarily engages with the first engagement surface 30E of the adhesive layer 30 to protect and shield the first engagement surface 30E from adhering to unwanted or undesired surfaces not intended by the user

Protective sheet 40 also includes a first extension 40G. As best seen in FIG. 3, first extension 40G protrudes outwardly from the first side 40C along the transverse axis of the protective sheet 40. Upon assembly, first extension 40G aligns with the first extension 30G of adhesive layer 30 (see FIG. 1). It should be understood that the size, shape, and configuration of first extension 40G matches with the size, shape, and configuration of the first extension 30G of the adhesive layer 30 and the first extension 10G of the base layer 10. As such, the first extension 40G defines the first width “W1” and the first length “L1” similar to first extensions 10G, 30G of base layer 10 and adhesive layer 30.

Still referring to protective sheet 40, protective sheet 40 also includes a second extension 40H. As best seen in FIG. 3, second extension 40H protrudes outwardly from the second side 40D along the transverse axis of the protective sheet 40. In the present disclosure, the second extension 40H is defined transversely opposite to the first extension 40G. Second extension 40H includes a first curvilinear edge 40H1 that extends outwardly from second side 40D to a planar edge 40H2. Second extension 40H also includes a second curvilinear edge 40H3 that extends outwardly from second side 40D to the planar edge 40H2 and is longitudinally opposite to the first curvilinear edge 40H1. Upon assembly, second extension 40H aligns with the second extension 30H of adhesive layer 30 such that the first curvilinear edge 40H1 aligns with the first curvilinear edge 30H1 of adhesive layer 30, the planar edge 40H2 aligns with the planar edge 30H2 of adhesive layer 30, and the second curvilinear edge 40H3 aligns with the second curvilinear edge 30H3 of adhesive layer 30.

It should be understood that the size, shape, and configuration of second extension 40H matches with the size, shape, and configuration of the second extension 30H of the adhesive layer 30 and the second extension 10H of the base layer 10. As such, the second extension 40H defines the second width “W2” and the second length (not illustrated) similar to second extensions 10H, 30H of base layer 10 and adhesive layer 30.

Still referring to protective sheet 40, protective sheet 40 also includes a cutline or split 40J that splits the protective sheet 40 into a first portion 42A and a second portion 42B. Such cutline 40J enables a user to remove the protective sheet 40 with ease when the user is ready to adhere the adhesive layer 30 to the user's digit or hand. In one exemplary embodiment, the cutline 40J may be omitted from the protective sheet 40 such that the protective sheet 40 is one, unitary member.

In the present disclosure, wearable gaming grip 1 is made a flexible material that may contour to any applicable surface, including a user's digit or hand. In one instance, wearable gaming grip 1 may be made from a woven fabric material, particularly the base layer 10, that includes a commercially-available adhesive material or element, particularly the adhesive layer 30.

The structural configuration of wearable gaming grip 1 is considered advantageous at least because the wearable gaming grip 1 provides multiple functions when using a peripheral gaming device. In one instance, the base layer 10, the gripping members 20, and the adhesive layer 30 provides a barrier or cushion between a user's digit or hand and the peripheral gaming device. Such barrier between the user's digit or hand and a peripheral gaming device combats against skin irritation thus removing the risk of blisters, sores, and other skin related injuries by eliminating direct friction between a user's skin and the peripheral gaming device. In another instance, the gripping member 20 may also enhance a user's grip and prevent slippage when actuating and/or interacting with one or more input components provided on a peripheral gaming device. In yet another instance, the inclusion of the plurality of voids 10J, 30J of the base layer 10 and the adhesive layer 30 may allow for breathability of the wearable gaming grip 1 to reduce perspiration along the user's digit or hand. Stated differently, the inclusion of the plurality of voids 10J, 30J of the base layer 10 and the adhesive layer 30 allows for air to pass through the wearable gaming grip 1 to prevent excessive perspiration when the user is wearing the wearable gaming grip 1 and gripping one or more input components of a peripheral gaming device with said wearable gaming grip 1.

In the present disclosure, wearable gaming grip 1 may be broken and/or sectioned into three portions or areas. As best seen in FIG. 5, wearable gaming grip 1 includes a first portion or area (denoted by double arrows labeled 1A in FIG. 5) that defines the first extensions 10G, 30G, 40G and the gripping members 20. Wearable gaming grip 1 includes a second portion or area (denoted by double arrows labeled 1B in FIG. 5) that is measured from the first end 10A to the first portion 1A. Wearable gaming grip 1 also includes a third portion or area (denoted by double arrows labeled 1C in FIG. 5) that is measured from the second end 10B to the first portion 1A.

Having now described the components and features of the wearable gaming grips 1, 1′, a method of using a wearable gaming grip 1, 1′ is discussed is greater detail below.

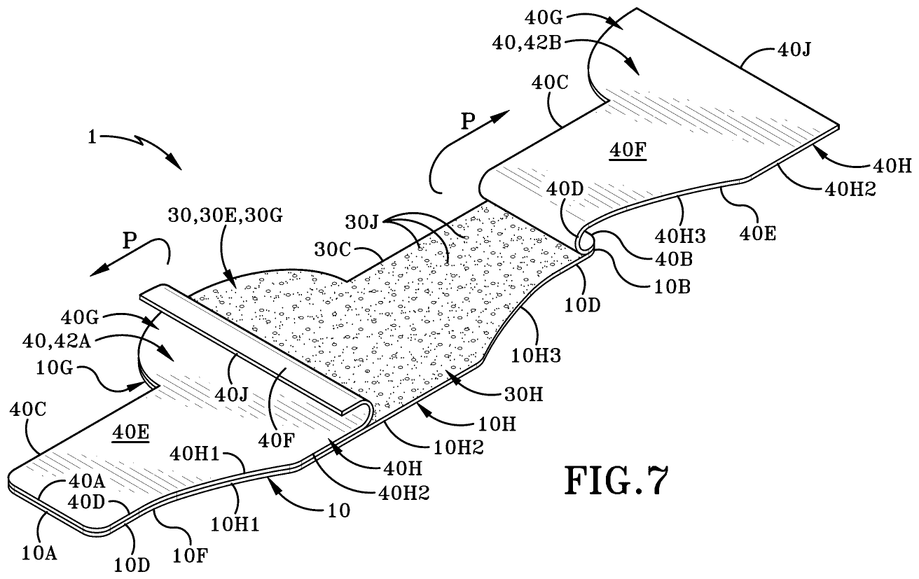

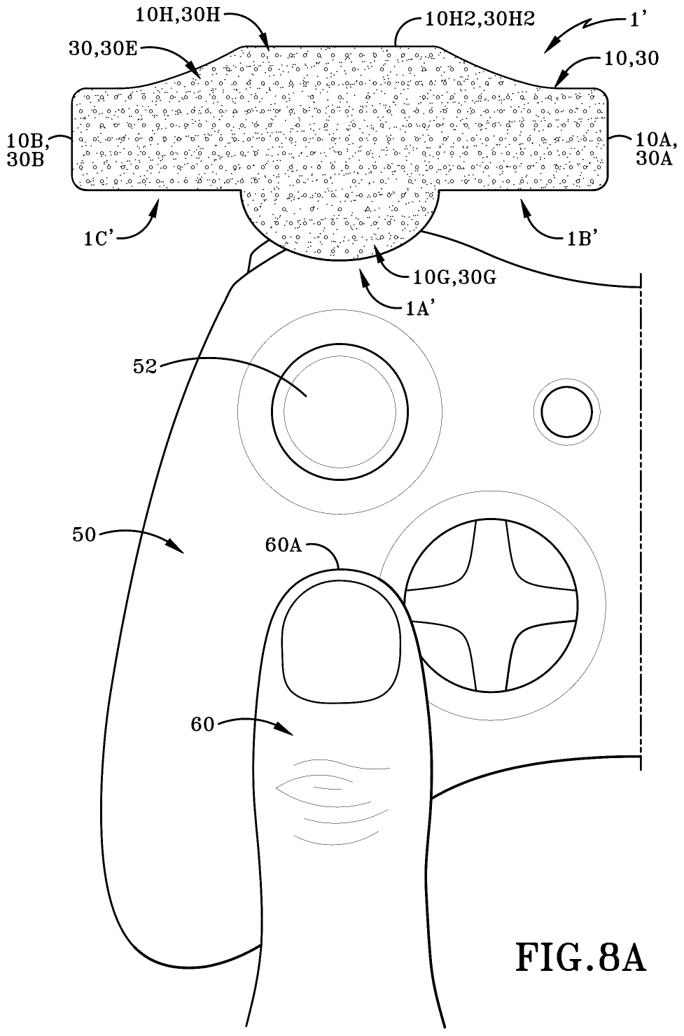

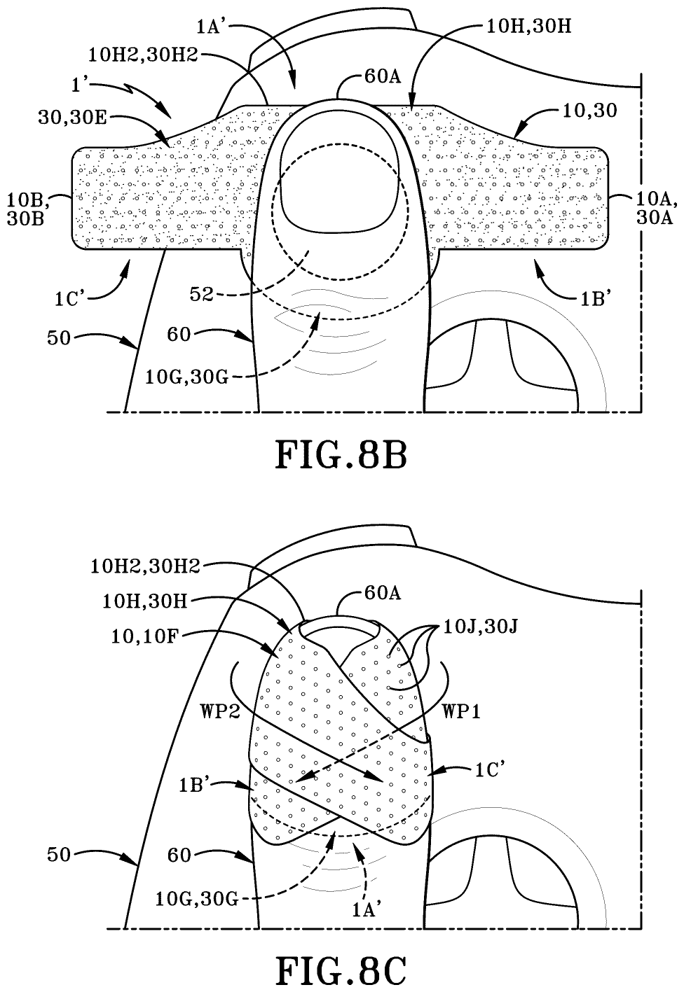

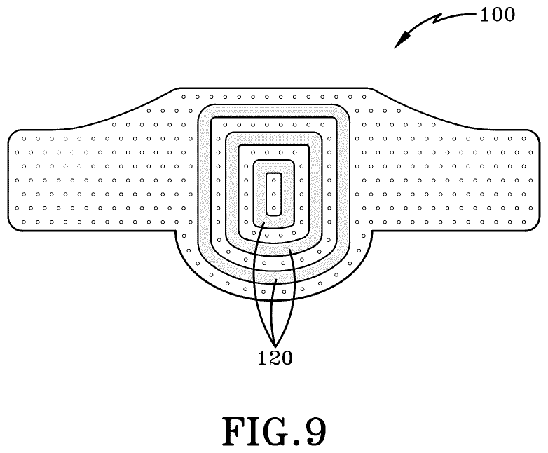

Prior to adhering the wearable gaming grip 1 to a user's digit or hand, the user initially removes the protective sheet 40 from the adhesive layer 30. As best seen in FIG. 7, user peels off each of the first portion 42A and the second portion 42B of the protective sheet 40 from the adhesive layer 30 at the cutline 40J. Such act of peeling and/or removing the first portion 42A and the second portion 42B of the protective sheet 40 from the adhesive layer 30 at the cutline 40J is denoted by arrows labeled “P” shown in FIG. 8. Upon removing the protective sheet 40, the user may then introduce the wearable gaming grip 1′ (denoting the protective sheet has been removed) to a peripheral gaming device 50 and a user's digit 60 (see FIG. 8A).

Prior to adhering the wearable gaming grip 1′ the user's digit 60, the wearable gaming grip 1′ is placed on a desired input component (e.g., a joystick 52) to ensure the wearable gaming grip 1′ is worn to match the desired input component (see FIG. 8B). Particularly, the gripping members 20 are placed on the joystick 52 of the peripheral gaming device 50 while the adhesive layer 30 faces away from the peripheral gaming device 50. The user may then place and/or rest the user's digit 60 (e.g., user's thumb) on the adhesive layer 30 (particularly the first portion 1A′) until the desired surface of the user's digit 60 is adhered with the adhesive layer 30 (see FIG. 8B). A tip 60A of the user's digit 60 is also positioned beyond the second extensions 10H2, 30H2 when the user places and/or rest the user's digit 60 on the wearable gaming grip 1′. The user may then wrap the remaining wearable gaming grip 1′ about the user's digit 60 to ensure the wearable gaming grip 1′ is completely secured to the user's digit 60. Particularly, the user may wrap the second and third portions 1B′, 1C′ of the base layer 10 and the adhesive layer 30 about the user's digit 60 to ensure the wearable gaming grip 1′ is completely secured to the user's digit 60 (see FIG. 8C). Such wrapping of the second and third portions 1B′, 1C′ of the base layer 10 and the adhesive layer 30 about the user's digit 60 is denoted by arrows labeled “WP1” when wrapping the second portion 1B′ and “WP2” when wrapping the third portion 1C′ in FIG. 8C.

In the present disclosure, wearable gaming grip 1 is shown temporarily operably engaged with a user's digit, particularly the user's thumb 60, to aid and improve performance when operating the joystick 52 of the peripheral gaming device 50. While wearable gaming grip 1 is being demonstrated on the user's thumb 60, such demonstration should not limit the use of temporarily engaging one or more wearable gaming grips 1 on one or more user's digits or hands. Examples of suitable locations for temporarily engaging wearable gaming grip 1 include, but not limited to, a user's index finger, a user's middle or long finger, a user's ring finger, a user's small finger, a user's palm, and other desired surfaces or positions of a user's hand based on the needs of the user.

In the present disclosure, wearable gaming grip 1 is shown being used with the joystick 52 of the peripheral gaming device. While wearable gaming grip 1 is being demonstrated with the joystick 52 of the peripheral gaming device 50, such demonstration should not limit the use of wearable gaming grip 1 being used with other input components provided with a peripheral gaming device. Examples of suitable input components provided with a peripheral gaming device that user may use wearable gaming grip 1 include, but not limited to, buttons, triggers, bumpers, keys, and other suitable input components that are provided with peripheral gaming devices.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A wearable gaming grip, comprising:
a base layer having a first engagement surface and a second engagement surface opposite to the first engagement surface;
an adhesive layer operably engaged with the first engagement surface and adapted to adhere to a user's digit; and
a plurality of gripping members operably engaged with the second engagement surface and adapted to engage with one or more input components of a peripheral gaming device.

2. The wearable gaming grip of claim 1, further comprising:
a plurality of voids defined between the first engagement surface and the second engagement surface of the base layer;
wherein a flow of air passes through the base layer at one or more voids of the plurality of voids.

3. The wearable gaming grip of claim 2, wherein each void of the plurality of voids is defined between two adjacent gripping members of the plurality of gripping members.

4. The wearable gaming grip of claim 2, wherein the plurality of voids are further defined between the first engagement surface and the second engagement surface of the adhesive layer.

5. The wearable gaming grip of claim 2, further comprising:
a first diameter defining each void of the plurality of voids; and
a second diameter defining each gripping member of the plurality of gripping members;
wherein the second diameter is greater than the first diameter.

6. The wearable gaming grip of claim 1, further comprising:
a first side;
a second side transversely opposite to the first side;
a first extension extending outwardly from the first side; and
a second extension extending outwardly from second side opposite to the first extension;
wherein the first extension covers a first portion of the user's digit; and wherein the second extension covers a second portion of the user's digit.

7. The wearable gaming grip of claim 6, further comprising:
a first width defined by the first extension; and
a second width defined by the second extension that is less than the second width.

8. The wearable gaming grip of claim 6, further comprising:
a first length defined by the first extension; and
a second length defined by the second extension that is equal to the first length.

9. The wearable gaming grip of claim 6, wherein the first extension defines a curvilinear two-dimensional shape.

10. The wearable gaming grip of claim 6, further comprising:
a first end;
a second end longitudinally opposite to the first end;
a first portion defining the first extension and the second extension;
a second portion defined between the first end and the first portion; and
a third portion defined between the second end and the first portion and is longitudinally opposite to the first portion.

11. The wearable gaming grip of claim 10, wherein the first portion is configured to engage with a first surface of the user's digit; and
wherein the second portion and the third portion are each configured to operably engage with a second surface of the user's digit that is behind the first surface.

12. The wearable gaming grip of claim 10, wherein the plurality of gripping members is engaged with the first portion and free from engaging with the second portion and the third portion.

13. The wearable gaming grip of claim 1, wherein each gripping member of the plurality of gripping members defines a circular two-dimensional shape.

14. The wearable gaming grip of claim 1, wherein each gripping member of the plurality of gripping members defines an ovoidal two-dimensional shape.

15. The wearable gaming grip of claim 1, further comprising:
a protective sheet operably engaged with the adhesive layer to prevent adhesion with the adhesive layer.

16. A method of gripping a joystick of a peripheral gaming device, the method comprising steps of:
removing a protective sheet of a wearable gaming grip from an adhesive layer of the wearable gaming grip;
resting a plurality of gripping members and a base layer of the wearable gaming grip on the joystick of the peripheral gaming device;
adhering a user's digit on the adhesive layer of the wearable gaming grip;
wrapping at least one portion of the adhesive layer of the wearable gaming grip about the user's digit; and
gripping one or more input components of the peripheral gaming device with the one or more gripping members of the plurality of gripping members.

17. The method of claim 16, further comprising:
aligning a first portion of the base layer with the joystick of the peripheral gaming device and a first surface of the user's digit;
wherein the plurality of gripping members is disposed on the first portion of the base layer.

18. The method of claim 17, wherein the step of aligning the first portion of the base layer with the joystick further comprises:
aligning a first extension of the base layer with a base of the user's digit; and
aligning a second extension of the base layer with a tip of the user's digit.

19. The method of claim 17, wherein the step of wrapping at least one portion of the adhesive layer of the wearable gaming grip about the user's digit further comprising:
wrapping a second portion of the adhesive layer about the user's digit;
wrapping a third portion of the adhesive layer about the user's digit and the second portion;
adhering the second portion of the adhesive layer to the user's digit; and
adhering the third portion of the adhesive layer to the user's digit and the third portion.

20. The method of claim 16, further comprising:
defining a plurality of voids inside of the base layer and the adhesive layer; and
passing air through the base layer and the adhesive layer via the plurality of voids.
